(19) United States
(12) Patent Application Publication
(10) Pub. No.: US 2016/0162521 A1
(43) Pub. Date: Jun. 9, 2016

(54) Systems and Methods for Data Ingest in Interest-Driven Business Intelligence Systems

(71) Applicant: Platfora, Inc., San Mateo, CA (US)

(72) Inventors: Mayank Pradhan, San Jose, CA (US); Honray Lin, Mountain View, CA (US); Kevin Scott Beyer, San Francisco, CA (US); Hans-Frederick Brown, San Rafael, CA (US)

(73) Assignee: Platfora, Inc.

(21) Appl. No.: 14/799,373

(22) Filed: Jul. 14, 2015

Related U.S. Application Data
(60) Provisional application No. 62/089,135, filed on Dec. 8, 2014.

(51) Int. Cl. G06F 17/30; G06Q 10/10

(52) U.S. Cl. CPC G06F 17/30318; G06F 17/30563; G06F 17/30342; G06Q 10/10; G06F 17/30592

(57) ABSTRACT

Systems and methods for data ingest in interest-driven business intelligence systems in accordance with embodiments of the invention are illustrated. The interest-driven business intelligence system may maintain a set of registered data ingest instruction data that includes at least one registered data ingest instruction data. Each of the at least one registered data ingest instruction data includes an identifier and data ingest instruction data associated with the identifier. The system may receive a request to generate data using registered data instruction data. The request may include the identifier of the registered data instruction data. Data is generated using the data ingest instruction data associated with the requested identifier and at least one of raw data, source data, and aggregate data, and provided for use.

### CROSS-REFERENCE TO RELATED APPLICATIONS

The current application claims priority to U.S. Provisional Patent Application Ser. No. 62/089,135, filed Dec. 8, 2014, the disclosure of which is hereby incorporated by reference in its entirety.

### FIELD OF THE INVENTION

The present invention is generally related to business intelligence systems and more specifically to processing data in business intelligence systems.

### BACKGROUND

The term “business intelligence” is commonly used to refer to techniques for identifying, processing, and analyzing business data. Business intelligence systems can provide historical, current, and predictive views of business operations. Business data, generated during the course of business operations, including data generated from business processes and the additional data created by employees and customers, can be structured, semi-structured, or unstructured depending on the context and knowledge surrounding the data. In many cases, data generated from business processes is structured, whereas data generated from customer interactions with the business is semi-structured or unstructured. Due to the amount of data generally generated during the course of business operations, business intelligence systems are commonly built on top of and/or utilize a data warehouse.

Data warehouses are utilized to store, analyze, and report data such as business data. Data warehouses utilize databases to store, analyze, and harness the data in a productive and cost-effective manner. A variety of databases are commonly utilized including a relational database management system (RDBMS), such as the Oracle Database from the Oracle Corporation of Santa Clara, Calif., or a massively parallel processing analytical database, such as Teradata from the Teradata Corporation of Miamisburg, Ohio. Business intelligence (BI) and analytical tools, such as SAS from SAS Institute, Inc. of Cary, N.C., are used to access the data stored in the database and provide an interface for developers to generate reports, manage and mine the stored data, perform statistical analysis, business planning, forecasting, and other business functions. Most reports created using BI tools are created by database administrators and/or business intelligence specialists, and the underlying database can be tuned for the expected access patterns. A database administrator can index, pre-aggregate or restrict access to specific relations, allow ad-hoc reporting and exploration.

A snowflake schema is an arrangement of tables in a RDBMS, with a central fact table connected to one or more dimension tables. The dimension tables in a snowflake schema are normalized into multiple related tables—for a complex schema there will be many relationships between the dimension tables, resulting in a schema that looks like a snowflake. A star schema is a specific form of a snowflake schema having a fact table referencing one or more dimension tables. However, in a star schema, the dimensions are normalized into a single table—the fact table is the center and the dimension tables are the “points” of the star.

Online transaction processing (OLTP) systems are designed to facilitate and manage transaction-based applications. OTLP can refer to a variety of transactions such a database management system transactions, business, or commercial transactions. OLTP systems typically have low latency response to user requests.

Online analytical processing (OLAP) is an approach to answering multidimensional analytical queries. OLAP tools enable users to analyze multidimensional data utilizing three basic analytical operations: consolidation (aggregating data), drill-down (navigating details of data), and slice and dice (take specific sets of data and view from multiple viewpoints). The basis for many OLAP systems is an OLAP cube. An OLAP cube is a data structure allowing for fast analysis of data with the capability of manipulating and analyzing data from multiple perspectives. OLAP cubes are typically composed of numeric facts, called measures, categorized by dimensions. These facts and measures are commonly created from a star schema or a snowflake schema of tables in a RDBMS.

### SUMMARY OF THE INVENTION

Systems and methods for data ingest in interest-driven business intelligence systems in accordance with embodiments of the invention are illustrated. In accordance with some embodiments of the invention, an interest-driven business intelligence server system performs in the following manner to store and provide registered functions represented as data ingest instruction data. The interest-driven business intelligence server system maintains a set of registered data ingest instruction data that includes at least one registered data ingest instruction data. Each of the at least one registered data ingest instruction data includes an identifier and data ingest instruction data associated with the identifier. The interest-driven business intelligence server system receives a request to generate data using registered data instruction data. The request may include the identifier of the registered data instruction data. Data is generated using the data ingest instruction data associated with the requested identifier and at least one of raw data, source data, and aggregate data, provided for use.

In accordance with some embodiments, the interest-driven business intelligence server system may analyze the generated data and generate statistic data that includes statistics for the generated data that may be provided for use. In accordance with many embodiments, the statistic data is provided as metadata associated with the generated data.

In accordance with some embodiments, the generating of the data using data ingest instruction data includes updating a set of data generated using the data ingest instruction data associated with the identifier.

In accordance with some embodiments, the interest-driven business intelligence server system stores the generated data in memory.

In accordance with a number of embodiments, the e interest-driven business intelligence server system receives a request to register data ingest instruction data, an identifier associated with the data ingest instruction data to register, and code written in a supported language to generate the data ingest instruction data. The system compiles the code to generate the data ingest instruction data and stores the data ingest instruction data and the associated identifier as registered data ingest instruction data in memory. In accordance with a number of embodiments, the interest-driven business intelligence server system generate datas using the data ingest instruction data associated with the identifier in response to compiling the code to generate the data ingest instruction data and stores the generated data in memory as part of a data catalog maintained in memory, wherein the data is associated with the identifier in the data catalog.

In accordance with some embodiments, the registered data ingest instruction data is a function to perform on a set of data. In accordance with many embodiments, the system receives an identification of a set of data to which the registered data ingest instruction data is to be applied and obtains the set of data. The ingest instruction data associated with the identifier is applied to the set of data to generate data. In accordance with some of these embodiments, the server system receives a change to at least one variable in a set of parameters for the data ingest instruction data exposed for use and the ingest instruction data is applied with to the data set using the change to the at least one variable in the set of parameter exposed for use.

In accordance with some embodiments, the interest-driven business intelligence server system receives a request to register data ingest instruction data that provides a function, an identifier associated with the data ingest instruction data to register, code written in a supported language to generate the data ingest instruction data, and a set of parameters including at least one variable for the data ingest instruction data that provides the function to expose to a user to allow the user to change. The system compiles the code to generate the data ingest instruction data and stores the data ingest instruction data, the exposed set of parameters and the associated identifier as registered data ingest instruction data in memory.

### BRIEF DESCRIPTION OF THE DRAWINGS

FIG. 1 is a network diagram of an interest-driven business intelligence system in accordance with an embodiment of the invention.

FIG. 2 is a conceptual illustration of an interest-driven business intelligence server system in accordance with an embodiment of the invention.

FIGS. 3A-3H are conceptual illustrations of user interfaces for data ingest and interest-driven data explorations in accordance with embodiments of the invention.

FIG. 4 is a flow chart illustrating a process for ingesting data into a raw data store in accordance with an embodiment of the invention.

FIG. 5 is a flow chart illustrating a process for ingesting data for generating reports in accordance with an embodiment of the invention.

FIG. 6 is a flow chart illustrating a process for generating data ingest instruction data in accordance with an embodiment of the invention.

FIG. 7 is a flow chart illustrating a process for registering a function in accordance with an embodiment of the invention.

FIG. 8 is a flow chart illustrating a process for applying data ingest instruction data to registered functions in accordance with an embodiment of the invention.

FIG. 9 is a flow chart illustrating a process for registering a set of data in accordance with an embodiment of the invention.

FIG. 10 is a flow chart illustrating a process for providing access to registered sets of data in accordance with an embodiment of the invention.

### DETAILED DISCLOSURE OF THE INVENTION

Turning now to the drawings, systems and methods for data ingest in interest-driven business intelligence systems in accordance with embodiments of the invention are illustrated. Interest-driven business intelligence systems include interest-driven business intelligence server systems configured to create reporting data using raw data retrieved from distributed computing platforms. The interest-driven business intelligence server systems can be configured to dynamically compile interest-driven data pipelines to provide analysts with information of interest from the distributed computing platform. The interest-driven business intelligence server system can have the ability to dynamically reconfigure the interest-driven data pipeline to provide access to desired information stored in the distributed computing platform. An interest-driven data pipeline is dynamically compiled to create reporting data based on reporting data requirements determined by analysts within the interest-driven business intelligence system. Changes specified at the report level can be automatically compiled and traced backward by the interest-driven business intelligence server system to compile an appropriate interest-driven data pipeline to meet the new and/or updated reporting data requirements. Interest-driven business intelligence server systems further build metadata concerning the data available in the interest-driven business intelligence system and provide the metadata to interest-driven data visualization systems to enable the construction of reports using the metadata. In this way, interest-driven business intelligence server systems are capable of managing huge datasets in a way that provides analysts with complete visibility into the available data. Available data within an interest-driven business intelligence system includes, but is not limited to, raw data, aggregate data, filtered data, and reporting data. Interest-driven business intelligence systems and interest-driven business intelligence server systems that can be utilized in accordance with embodiments of the invention are discussed further in U.S. Pat. No. 8,447,721, titled “Interest-Driven Business Intelligence Systems and Methods of Data Analysis Using Interest-Driven Data Pipelines” and issued Can 21, 2013, the entirety of which is incorporated herein by reference.

In many embodiments, the reports are created using interest-driven data visualization systems configured to request and receive data from an interest-driven business intelligence server system. Systems and methods for interest-driven data visualization that can be utilized in accordance with embodiments are described in U.S. Patent Publication Serial No. 2014/0114970, titled “Systems and Methods for Interest-Driven Data Visualization Systems Utilized in Interest-Driven Business Intelligence Systems” and filed Mar. 8, 2013, the entirety of which is hereby incorporated by reference. In order for an interest-driven data visualization system to build reports, a set of reporting data requirements are defined. These requirements specify the reporting data (derived from raw data) that will be utilized to generate the reports. The raw data can be structured, semi-structured, or unstructured. In a variety of embodiments, structured and semi-structured data include metadata, such as an index or other relationships, describing the data; unstructured data lacks any definitional structure. An interest-driven business intelligence server system can utilize reporting data already created by the interest-driven business intelligence server systems and/or cause new and/or updated reporting data to be generated to satisfy the reporting data requirements. In a variety of embodiments, reporting data requirements are obtained from interest-driven data visualization systems based on reporting requirements defined by analysts exploring metadata describing raw data stored in the interest-driven business intelligence system. In many embodiments, reports utilized in interest-driven data visualization systems include a set of datasets determined using reporting data received from an interest-driven business intelligence server system and a set of visualizations.

Interest-driven data visualization systems are configured to enable the dynamic association of datasets to visualizations to provide a variety of interactive reports describing the data. In a number of embodiments, multiple datasets within a piece of reporting data (or multiple pieces of reporting data) can be visualized within a single visualization by utilizing a trellised visualization. A trellised visualization includes a plurality of visualizations. In several embodiments, at least one of these visualizations is designated as the master visualization and zero or more slave visualizations can be associated with the master visualization(s). Based on the relationships between the master visualizations and the slave visualizations, interactions with the master visualization(s) are mapped to the slave visualizations. In this way, the slave visualizations can be interacted with in concert with the corresponding master visualizations. Each of the visualizations within the trellised visualization is displayed simultaneously by the interest-driven data visualization system. Systems and methods for interest-driven data visualizations configured to generate trellised visualizations that can be utilized in accordance with embodiments of the invention are disclosed in U.S. patent application Ser. No. 14/140,211, titled “Systems and Methods for Interest-Driven Data Visualization Systems Utilizing Visualization Image Data and Trellised Visualizations” and filed Dec. 24, 2013, the entirety of which is hereby incorporated by reference.

Interest-driven business intelligence server systems are configured to provide reporting data based on one or more reporting data requirements. Reporting data provided by interest-driven business intelligence server systems includes raw data, aggregate data, event-oriented data, geo-spatial data, and/or filtered (e.g. projected) data loaded from raw data storage that has been processed and loaded into a data structure to provide rapid access to the data. It should be noted that any transformation of data loaded from raw data storage can be utilized as appropriate to the requirements of specific embodiments of the invention. In several embodiments, reporting data derived from aggregate data is referred to as aggregate reporting data; similarly, reporting data derived from geo-spatial data can be referred to as geo-spatial reporting data. Event-oriented data includes sets of data aligned along one or more of the dimensions of (e.g. columns of data within) the sets of data. Sets of data include, but are not limited to, fact tables and dimension tables as appropriate to the requirements of specific applications in accordance with embodiments of the invention. In this way, event-oriented data can include a variety of data across multiple sets of data that are organized by ordering data. Systems and methods for business intelligence systems including event-oriented data that can be utilized in accordance with embodiments of the invention are described in U.S. patent application Ser. No. 14/198,039, titled “Systems and Methods for Interest-Driven Business Intelligence Systems Including Event-Oriented Data” and filed Mar. 5, 2014. Systems and methods for business intelligence systems including geo-spatial data that can be utilized in accordance with embodiments of the invention are described in U.S. patent application Ser. No. 14/313,191, titled “Systems and Methods for Interest-Driven Business Intelligence Systems Including Geo-Spatial Data” and filed Jun. 24, 2014. The entirety of U.S. patent application Ser. Nos. 14/198,039 and 14/313,191 are hereby incorporated by reference.

Business intelligence systems, including interest-driven business intelligence systems in accordance with embodiments of the invention can be configured to provide segment data that can be explored using interest-driven data visualization systems. In a variety of embodiments, segment data includes data grouped by one or more pieces of segment grouping data. This segment grouping data can be utilized in the exploration of the segment data to quickly identify patterns of interest within the data. The data utilized within the segment data can be sourced from a variety of pieces of data, including source data, aggregate data, event-oriented data, geo-spatial data, and reporting data as appropriate to the requirements of specific applications in accordance with embodiments of the invention. Additionally, multiple segments can be combined together in order to explore patterns existing across multiple segments for one or more pieces of reporting data. Based on patterns identified within the (combined) segment data, specific pieces of reporting data can be generated targeting the identified patterns within the segment data. This reporting data can then be utilized to generate detailed reports for additional analysis and exploration of the patterns located within the (combined) segment data. In a variety of embodiments, metadata describing the (combined) segment data can be stored and utilized to generate updated segment data. This updated segment data can be utilized to further analyze patterns occurring within the reporting data as the underlying reporting data changes. Systems and methods for interest-driven business intelligence systems configured to utilize segment data that can be utilized in accordance with embodiments of the invention are described in U.S. patent application Ser. No. 14/197,150, titled “Systems and Methods for Interest-Driven Business Intelligence Systems including Segment Data” and filed Mar. 5, 2014, the entirety of which is hereby incorporated by reference.

In many embodiments, geo-spatial data reporting data is visualized and explored using interest-driven data visualization systems to analyze trends within the regions identified within the geo-spatial data reporting data. In several embodiments, these regions are based on boundary data that defines a particular region within the reporting data. In a number of embodiments, these regions are based on binning data that approximates a region within the reporting data defined based on boundary data. Based on the data associated with the analyzed regions, reporting data requirements identifying aggregate data can be used to create jobs and generate the aggregate data corresponding to the analyzed trends. The aggregate data can then be utilized to generate aggregate reporting data that can be analyzed to gain deeper insights into the regions identified within the geo-spatial data. Similarly, aggregate reporting data can be analyzed to identify potential regions of interest that form the basis for jobs to generate geo-spatial data describing the regions. The geo-spatial data can then be utilized to generate geo-spatial reporting data utilized by interest-driven data visualization systems to analyze the regions identified within the geo-spatial reporting data. Systems and methods for interest-driven business intelligence systems utilizing geo-spatial data that can be utilized in accordance with embodiments of the invention are described in U.S. patent application Ser. No. 14/313,191, incorporated by reference above.

In a number of embodiments, the raw data, aggregate data, event-oriented data, geo-spatial data, and/or filtered data can be provided to interest-driven business intelligence server systems as source data. In many embodiments, the source data is described by metadata describing the raw data, aggregate data, event-oriented data, geo-spatial data, and/or filtered data present in the source data. In several embodiments, the source data, aggregate data, event-oriented data, geo-spatial data, and/or reporting data is stored in a data mart or other aggregate data storage associated with the interest-driven business intelligence server system. Interest-driven business intelligence server systems can load source data into a variety of reporting data structures in accordance with a number of embodiments, including, but not limited to, online analytical processing (OLAP) cubes. In a variety of embodiments, the reporting data structures are defined using reporting data metadata describing a reporting data schema. In a number of embodiments, interest-driven business intelligence server systems are configured to combine requests for one or more OLAP cubes into a single request, thereby reducing the time, storage, and/or processing power utilized by the interest-driven business intelligence system in creating source data utilized to create reporting data schemas and/or the reporting data.

### Data Ingest

Many interest-driven business intelligence systems utilize ETL processes to generate some or all of the data utilized within the system. Data ingest instruction data can be utilized to generate and/or execute these ETL processes. In many embodiments, data ingest instruction data is utilized by interest-driven data pipelines to obtain, prepare, and/or generate data. In a number of embodiments, data ingest instruction data is utilized to directly generate aggregate data, source data, and/or reporting data based on raw data provided by one or more data sources. The data ingest instruction data can be utilized to obtain data from one or more data sources, in parallel and/or in series, as appropriate to the requirements of specific applications of the invention. In many embodiments, the data ingest instruction data includes instructions written in any of a variety of languages, such as the Scala language provided by École Polytechnique Fédérale de Lausanne of Lausanne, Switzerland. The data ingest instruction data can be pre-generated and/or generated using an interest-driven business intelligence server system and/or interest-driven data visualization system as appropriate to the requirements of specific application of embodiments of the invention. In several embodiments, pre-defined functions are provided that can be expressed using the data ingest instruction data. In this way, data ingest instruction data can be more easily created and executed to obtain data within the interest-driven business intelligence system. Furthermore, the data ingest instruction data itself can be shared (i.e. registered) throughout the entire interest-driven business intelligence system utilizing techniques similar to those described above. In this way, the data ingest instruction data can be utilized to share and/or update data as required by specific applications of embodiments of the invention.

In a variety of embodiments, the data ingest instruction data obtains raw data from one or more data sources. In several embodiments, the data ingest instruction data generates source data, aggregate data, and/or reporting data based on data provided by one or more data sources. In many embodiments, the data ingest instruction data is generated based on metadata describing raw data available from one or more data sources. In a number of embodiments, the data ingest instruction data is registered as a data catalog utilized by an interest-driven data visualization system. In this way, the data ingest instruction data can be utilized to obtain any of a variety of data (and/or metadata describing the data) as appropriate to the requirements of specific applications of the invention. For example, the data generated based on the data ingest instruction data can be profiled and statistics (and/or sample data) can be calculated and stored as metadata. This metadata can be utilized to preview the available data and/or provide estimates regarding the availability of the data. In many embodiments, the data ingest instruction data can be treated as a data source similar to those described above. In several embodiments, the data ingest instruction data provides a resilient distributed dataset. Furthermore, multiple pieces of data ingest instruction data can be chained together in order to provide more advanced analysis of the underlying data. Similarly, the data ingest instruction data can be associated with any other data available in the interest-driven business intelligence system, such as by linking primary and/or secondary keys and/or any other attributes and/or data as appropriate to the requirements of specific applications of embodiments of the invention. In this way, the data ingest instruction data along with any other data can be utilized to generate reporting data and visualize data utilizing techniques similar to those described above.

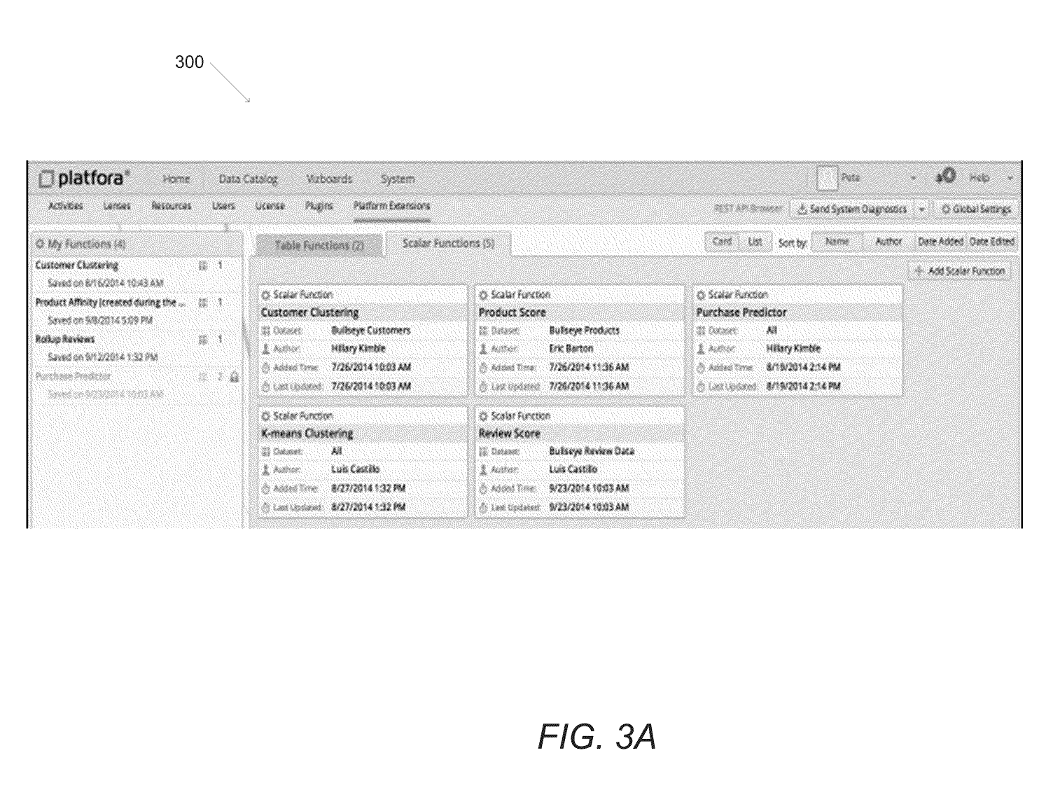

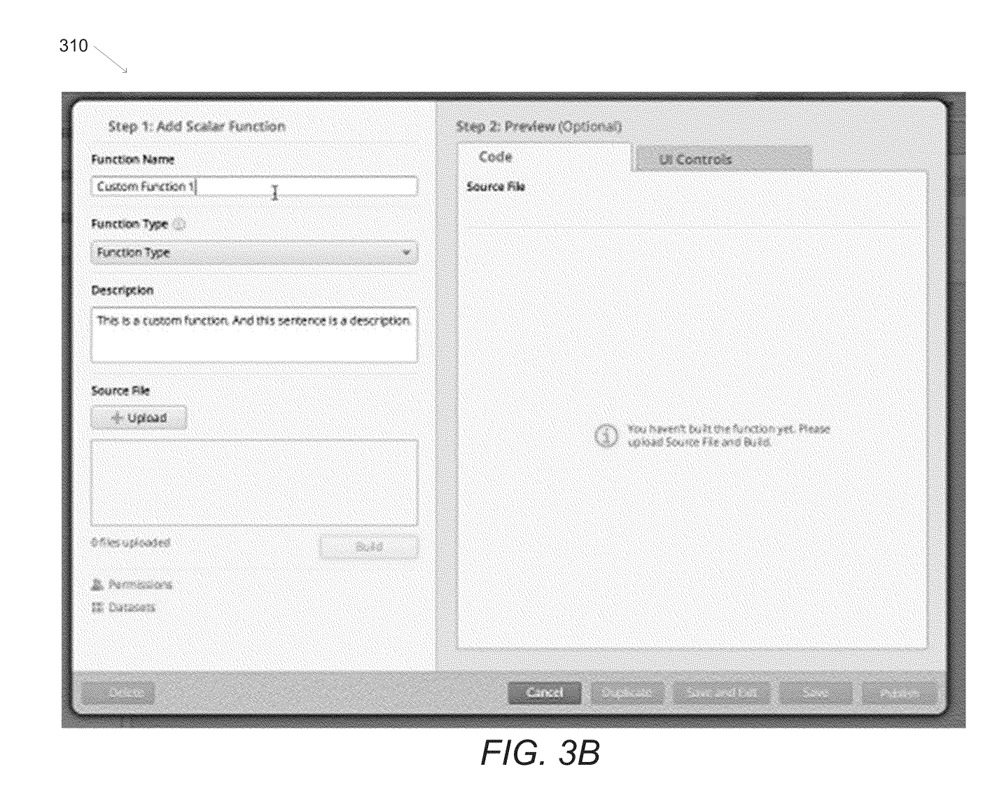

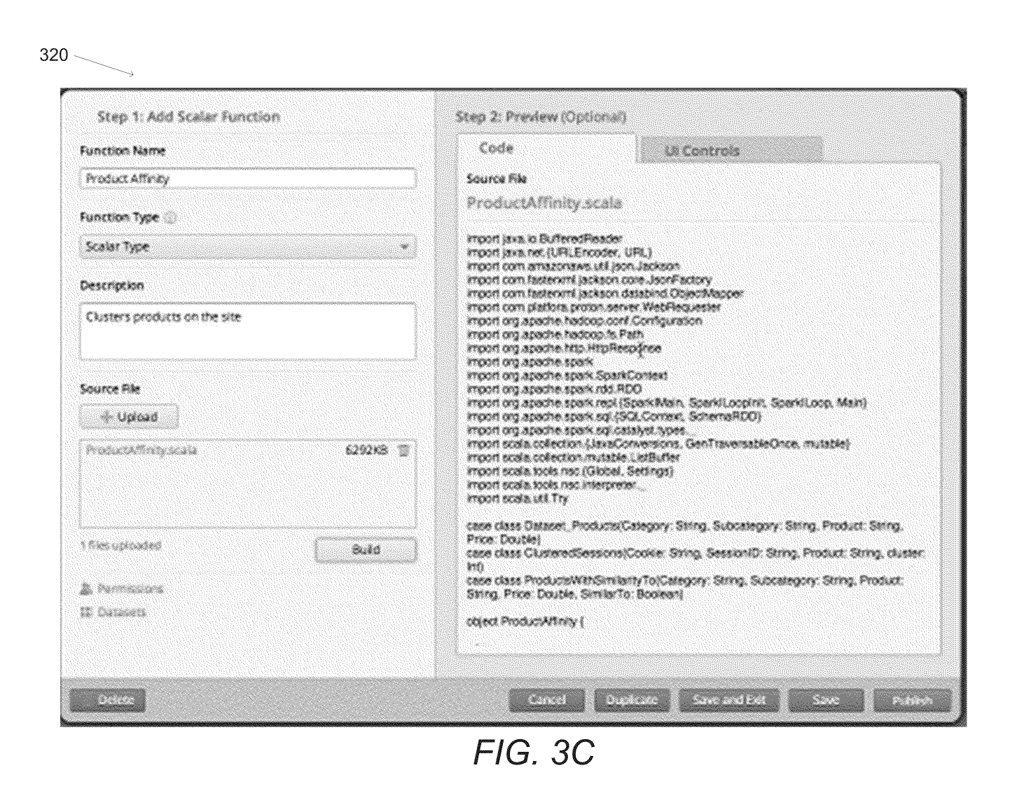

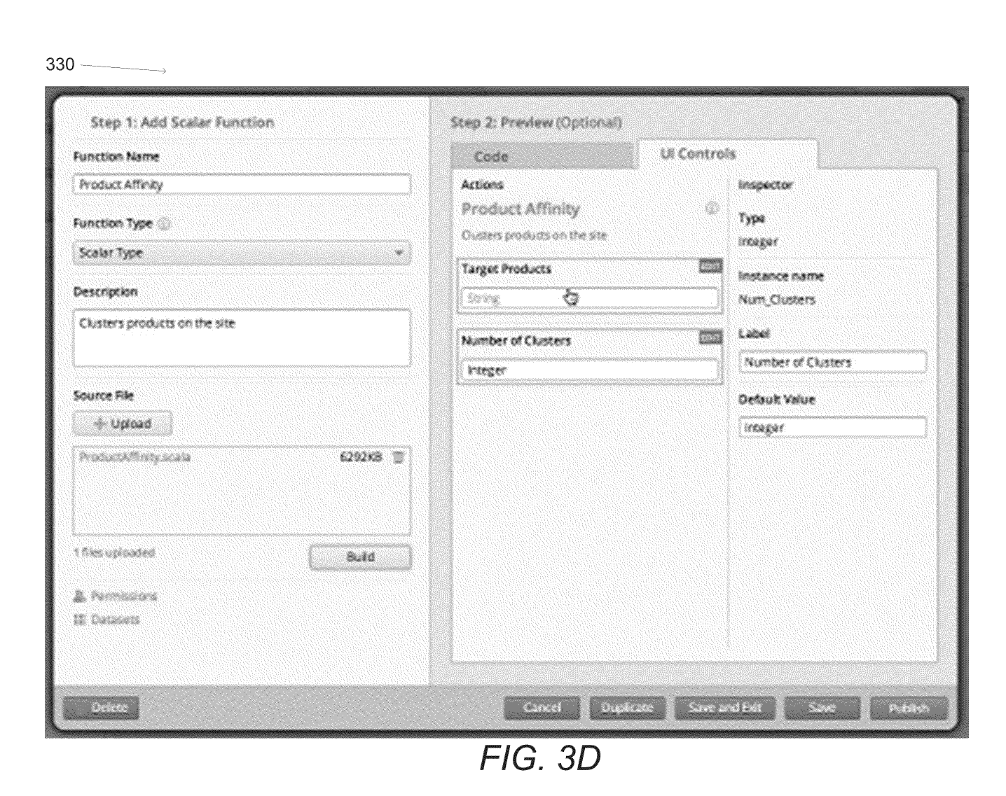

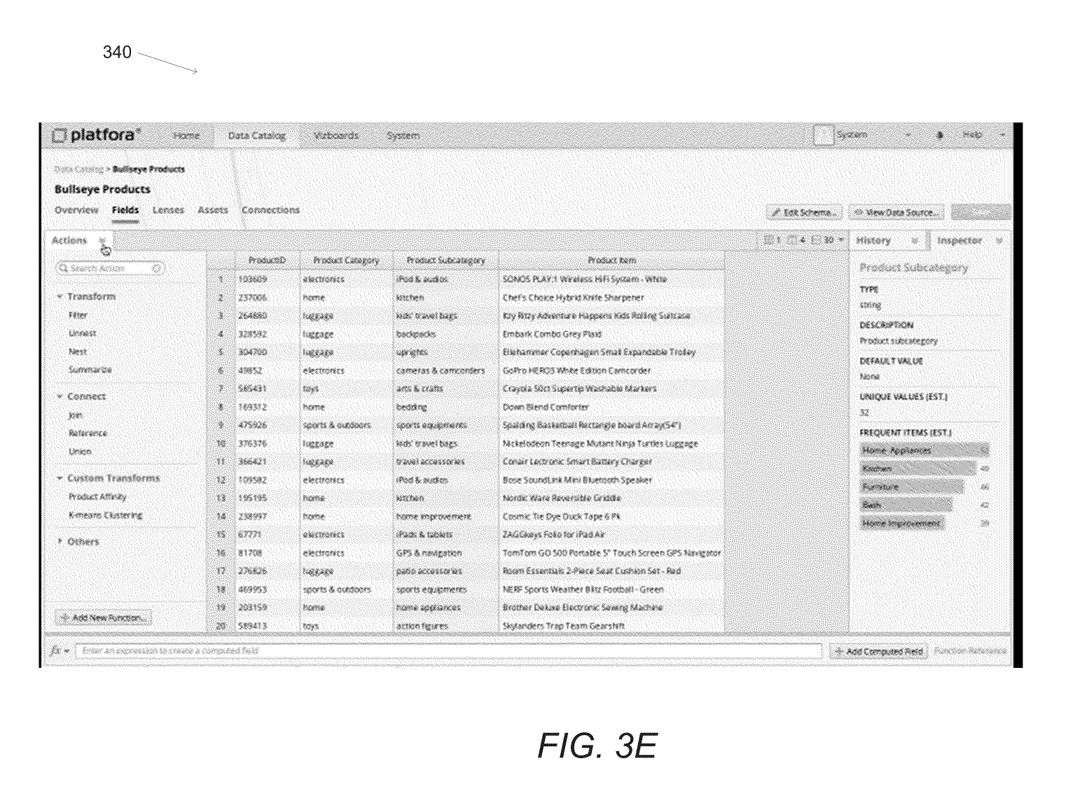

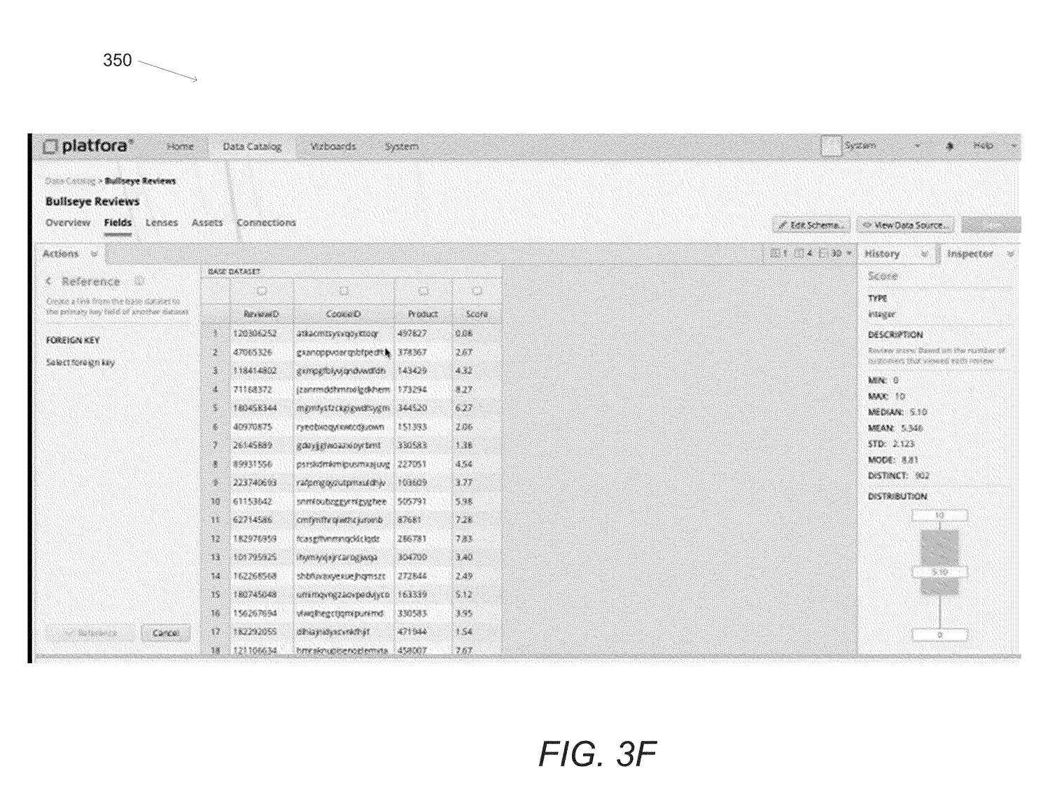

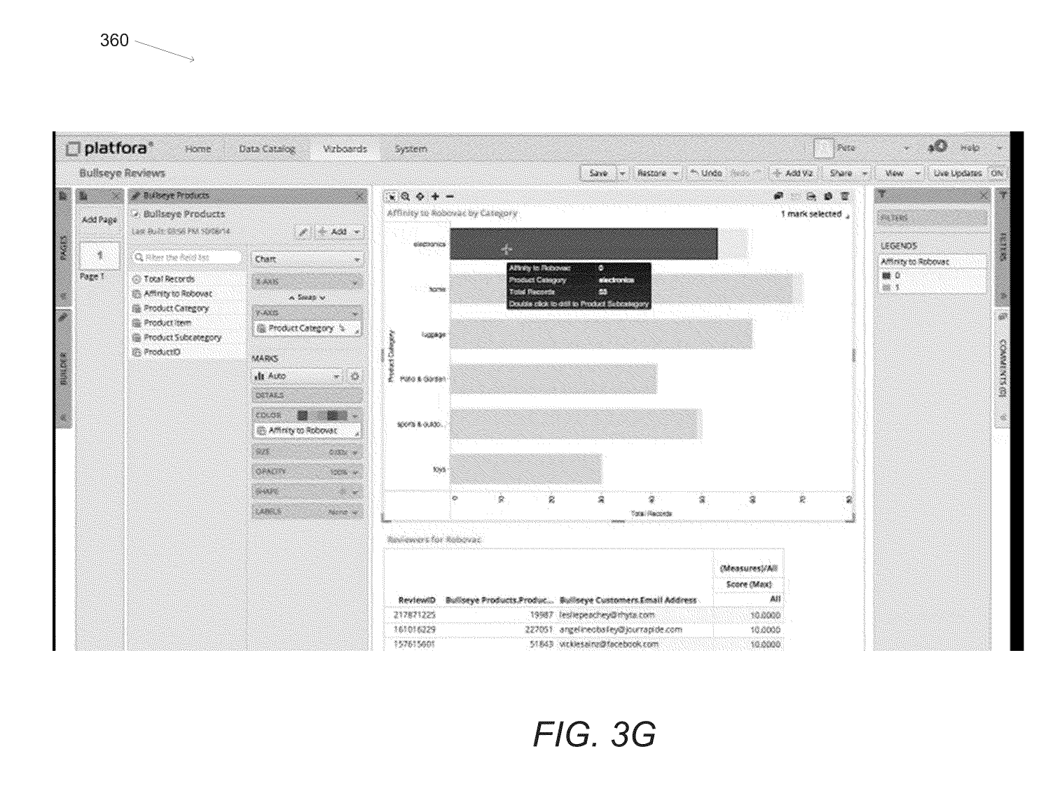

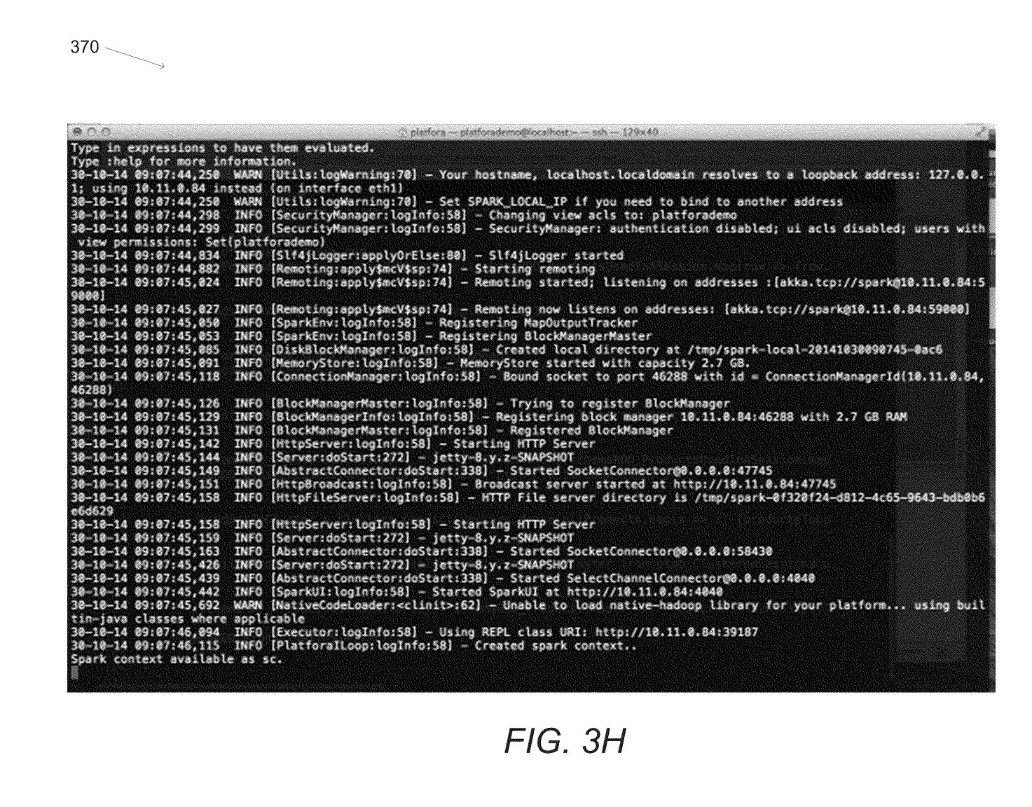

Turning now to FIGS. 3A-3H, screenshots illustrating defining, generating, executing, processing, and visualizing data generated based on and including data ingest instruction data in accordance with embodiments of the invention are shown. In several embodiments, FIGS. 3A-H illustrate the techniques described herein. In a variety of embodiments, the data ingest instruction data includes instructions for the Apache Spark framework provided by the Apache Software Foundation of Forest Hill, Md. In a number of embodiments, the data ingest instruction data includes instructions for a MapReduce-based framework, such as the Apache Hadoop framework provided by the Apache Software Foundation. However, any computing framework that executes instructions that can be described using data ingest instruction data can be utilized as appropriate to the requirements of specific applications of embodiments of the invention.

Systems and methods for interest-driven business intelligence systems including data ingest are described in more detail below.

### Interest-Driven Business Intelligence Systems

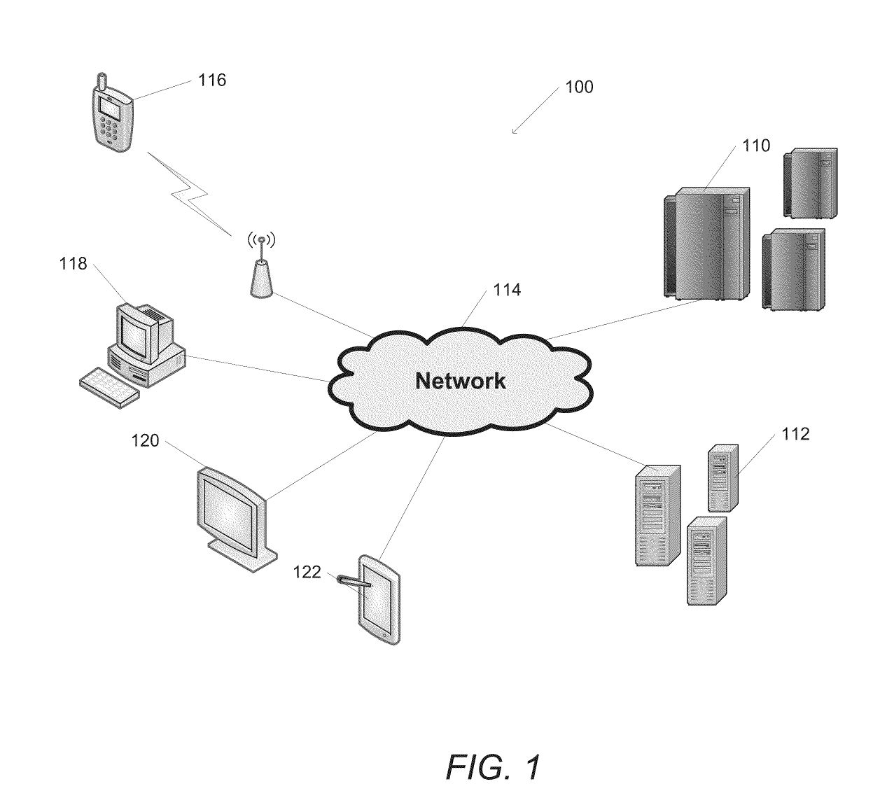

An interest-driven business intelligence system in accordance with an embodiment of the invention is illustrated in FIG. 1. The interest-driven business intelligence system 100 includes a distributed computing platform 110 configured to store raw business data. The distributed computing platform 110 can be configured to communicate with an interest-driven business intelligence server system 112 via a network 114. In several embodiments of the invention, the network 114 is a local area network, a wide area network, or the Internet; however, any network 114 can be utilized as appropriate to the requirements of specific applications in accordance with embodiments of the invention.

In a variety of embodiments, the distributed computing platform 110 is a cluster of computing devices configured as a distributed computing platform. The distributed computing platform 110 can be configured to act as a raw data storage system and a data warehouse within the interest-driven business intelligence system. In a number of embodiments, the distributed computing platform includes a distributed file system configured to distribute the data stored within the distributed computing platform 110 across the cluster computing devices. In many embodiments, the distributed data is replicated across the computing devices within the distributed computing platform, thereby providing redundant storage of the data. The distributed computing platform 110 can be configured to retrieve data from the computing devices by identifying one or more of the computing devices containing the requested data and retrieving some or all of the data from the computing devices. In a variety of embodiments where portions of a request for data are stored using different computing devices, the distributed computing platform 110 can be configured to process the portions of data received from the computing devices in order to build the data obtained in response to the request for data. Any distributed file system, such as the Hadoop Distributed File System (HDFS), can be utilized as appropriate to the requirements of specific applications in accordance with embodiments of the invention. In many embodiments, the interest-driven business intelligence server system 112 can be configured to generate data ingest instruction data and to utilize that data to obtain raw data, source data, and/or reporting data utilizing an interest-driven data pipeline.

In several embodiments, the interest-driven business intelligence server system 112 is implemented using one or a cluster of computing devices. In a variety of embodiments, alternative distributed processing systems are utilized. Raw data storage is utilized to store raw data, metadata storage is utilized to store data description metadata describing the raw data, and/or report storage is utilized to store previously generated reports including previous reporting data and previous reporting data requirements. Raw data storage, metadata storage, and/or report storage can be a portion of the memory associated with the interest-driven business intelligence server system 112, the distributed computing platform 110, and/or a separate device in accordance with the specific requirements of specific embodiments of the invention. In a variety of embodiments, the interest-driven business intelligence server system 112 and/or distributed computing platform 110 can be configured to generate an index for the raw data, metadata, and/or reporting data as appropriate to the requirements of specific applications of the invention. In several embodiments, the interest-driven business intelligence server system 112 and/or distributed computing platform 110 can be configured to access data directly without generating and/or referencing an index.

The interest-driven business intelligence server system 112 can be configured to communicate via the network 114 with one or more interest-driven data visualization systems, including, but not limited to, mobile devices 116, personal computers 118, presentation devices 120, and tablet devices 122. In many embodiments of the invention, interest-driven data visualization systems include any computing device capable of receiving and/or displaying data. Interest-driven data visualization systems allow users to specify reports including data visualizations that enable the user to explore the raw data stored within the distributed computing platform 110 using reporting data generated by the interest-driven business intelligence server system 112. Reporting data is provided in a variety of forms, including, but not limited to, snowflake schemas and star schemas as appropriate to the requirements of specific applications in accordance with embodiments of the invention. In many embodiments, reporting data is any data that includes fields of data populated using raw data stored within the distributed computing platform 110. The reporting data requested can include aggregate reporting data, event-oriented reporting data, and/or geo-spatial reporting data as appropriate to the requirements of specific applications in accordance with embodiments of the invention. In several embodiments, this data is generated based on data ingest instruction data that is provided to an interest-driven data pipeline.

The interest-driven business intelligence server system 112 can automatically compile one or more interest-driven data pipelines to create or update reporting data to satisfy the received reporting data requirements based on received reporting data requirements. The interest-driven business intelligence server system 112 can be configured to compile one or more interest-driven data pipelines configured to create and push down jobs (i.e. ETL processes and/or data ingest instruction data) to the distributed computing platform 110 to create source data and then applying various filtering, aggregation, alignment, bounding, and/or grouping processes to the source data to produce reporting data to be transmitted to interest-driven data visualization systems.

In many embodiments, the interest-driven business intelligence server system 112 includes reporting data, source data, event-oriented data, geo-spatial data, and/or aggregate data that partially or fully satisfy the reporting data requirements. The interest-driven business intelligence server system 112 can be configured to identify the relevant existing reporting data, aggregate data, event-oriented data, geo-spatial data, and/or source data and configure an interest-driven data pipeline to create jobs requesting reporting data minimizing the redundancy between the existing data and the new reporting data requirements. In a variety of embodiments, the interest-driven business intelligence server system 112 can be configured to determine redundancies between the requested data and existing data using metadata describing the data available from the distributed computing platform 110. In a number of embodiments, the metadata further describes what form the data is available in, such as, but not limited to, aggregate data, filtered data, source data, reporting data, event-oriented data, and geo-spatial data. In several embodiments, the interest-driven business intelligence server system 112 obtains a plurality of reporting data requirements and creates jobs using the interest-driven data pipeline to create source data containing data fulfilling the union of the plurality of reporting data requirements. In a variety of embodiments, the interest-driven business intelligence server system 112 can be configured to identify redundant data requirements in one or more reporting data requirements and configure an interest-driven data pipeline to create jobs requesting source data fulfilling the redundant data requirements. In several embodiments, the interest-driven business intelligence server system 112 can be configured to store aggregate data, event-oriented data, geo-spatial data, and/or reporting data in a data mart and utilize the stored data to identify the redundant data requirements. In a number of embodiments, the interest-driven business intelligence server system 112 can be configured to identify when reporting data requirements request updated data for existing reporting data and/or source data and configure an interest-driven data pipeline to create jobs to retrieve an updated snapshot of the existing reporting data from the distributed computing platform 110.

The interest-driven business intelligence server system 112 can be configured to compile an interest-driven data pipeline to create jobs to be pushed down to the distributed computing platform 110 in order to retrieve data. In a variety of embodiments, the jobs created using the interest-driven data pipeline are tailored to the reporting data requirements. In many embodiments, the jobs created using the interest-driven data pipeline are customized to the hardware resources available on the distributed computing platform 110. In a number of embodiments, the jobs are configured to dynamically reallocate the resources available on the distributed computing platform 110 in order to best execute the jobs. In several embodiments, the jobs are created using performance metrics collected based on the performance of previously executed jobs.

In several embodiments, jobs pushed down to the distributed computing platform 110 by the interest-driven business intelligence server system 112 cannot be executed in a low-latency fashion. In many embodiments, the distributed computing platform 110 can be configured to provide a partial set of source data fulfilling the pushed down job and the interest-driven business intelligence server system 112 can be configured to create reporting data using the partial set of source data. As more source data is provided by the distributed computing platform 110, the interest-driven business intelligence server system 112 can be configured to update the created reporting data based on the received source data. In a number of embodiments, the interest-driven business intelligence server system will continue to update the reporting data until a termination condition is reached. Termination conditions can include, but are not limited to, a certain volume of source data is received, the source data provided is no longer within a particular time frame, and an amount of time to provide the source data has elapsed. In a number of embodiments, a time frame and/or the amount of time to provide the source data is determined based on the time previously measured in the retrieval of source data for similar reporting data requirements.

Although a specific architecture for an interest-driven business intelligence system in accordance with an embodiment of the invention is conceptually illustrated in FIG. 1, any of a variety of architectures configured to store large data sets and to automatically build interest-driven data pipelines based on reporting data requirements can also be utilized. It should be noted that any of the data described herein could be obtained from any system in any manner (i.e. via one or more application programming interfaces (APIs) or web services) and/or provided to any system in any manner as appropriate to the requirements of specific applications of embodiments of the invention.

### Interest-Driven Business Intelligence Server Systems

Interest-driven business intelligence server systems in accordance with embodiments of the invention are configured to create jobs to request source data from interest-driven business intelligence systems based on received reporting data requirements and to create reporting data using the received source data. The reporting data can be aggregate reporting data, event-oriented reporting data, and/or geo-spatial reporting data based on the received reporting data requirements. It should be noted that any data derived from the source data can be utilized as reporting data as appropriate to the requirements of specific embodiments of the invention. In many embodiments, the generated jobs include data ingest instruction data. The data ingest instruction data can be tailored to the specific data requested and/or the data source providing the data as appropriate to the requirements of specific applications of embodiments of the invention.

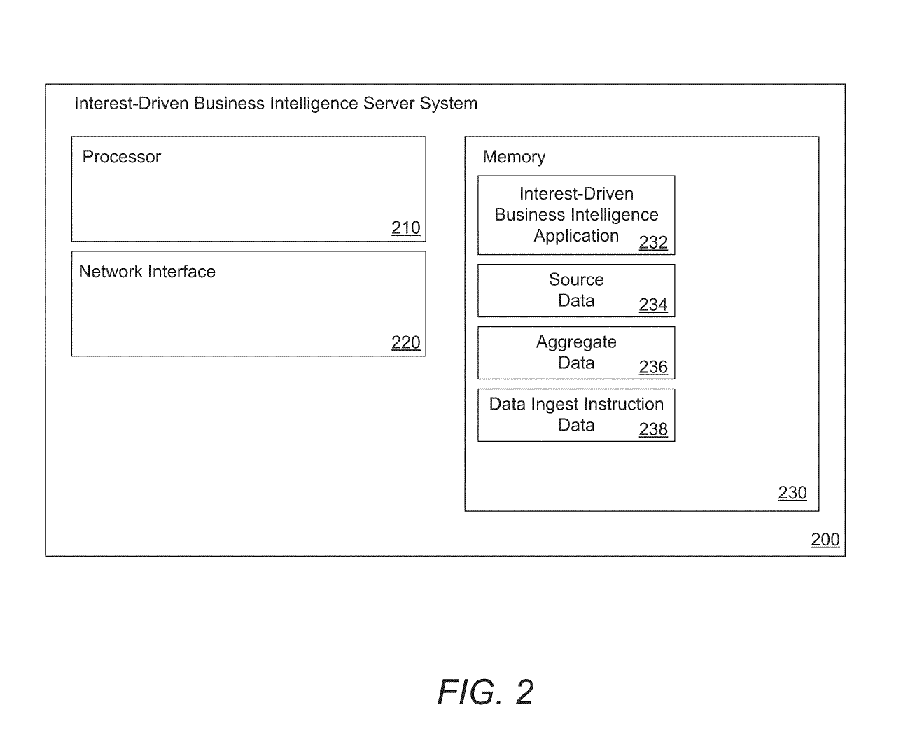

An interest-driven business intelligence server system in accordance with an embodiment of the invention is conceptually illustrated in FIG. 2. The interest-driven business intelligence server system 200 includes a processor 210 in communication with memory 230. The memory 230 is any form of storage configured to store a variety of data, including, but not limited to, an interest-driven business intelligence application 232, source data 234, aggregate data 236, and data ingest instruction data 238. The interest-driven business intelligence server system 200 also includes a network interface 220 configured to transmit and receive data over a network connection. In a number of embodiments, the network interface 220 is in communication with the processor 210 and/or the memory 230. In many embodiments, the interest-driven business intelligence application 232, source data 234, aggregate data 236, and/or data ingest instruction data 238 are stored using an external server system and received by the interest-driven business intelligence server system 200 using the network interface 220. External server systems in accordance with a variety of embodiments include, but are not limited to, distributed computing platforms and data marts. In several embodiments, the source data and/or aggregate data 236 are stored in a dictionary-encoded format. In a number of embodiments, the source data 234 and/or aggregate data 236 is stored using run length encoding and/or a sparse representation. It should be noted, however, that any encoding format could be utilized as appropriate to the requirements of specific applications in accordance with embodiments of the invention. In a variety of embodiments, the source data 234 and/or aggregate data 236 is stored as parallel arrays of data with each array representing the values of a particular field of data.

The interest-driven business intelligence application 232 configures the processor 210 to perform a variety of interest-driven business intelligence processes. In many embodiments, an interest-driven business intelligence process includes creating jobs (potentially including data ingest instruction data 238) using an interest-driven data pipeline to retrieve source data in response to reporting data requirements. The source data can then be utilized to generate aggregate data, event-oriented data, and/or geo-spatial data as appropriate to the requirements of specific applications in accordance with embodiments of the invention. In a variety of embodiments, the created jobs are based on redundancies between reporting data requirements and existing source data 234 and/or aggregate data 236. In a number of embodiments, the interest-driven business intelligence process includes updating reporting data based on incrementally received source data and/or updated source data. In several embodiments, the interest-driven business intelligence process includes obtaining a request for aggregate reporting data and generating the aggregate reporting data based on one or pieces of geo-spatial data. Similarly, the interest-driven business intelligence process can also include generating data ingest instruction data 238 based on the reporting data requirements and/or request for updated data and utilizing the data ingest instruction data 238 to obtain the necessary data.

Although a specific architecture for an interest-driven business intelligence server system in accordance with an embodiment of the invention is conceptually illustrated in FIG. 2, any of a variety of architectures, including those that store data or applications on disk or some other form of storage and are loaded into memory at runtime, can also be utilized. In a variety of embodiments, the memory 220 includes circuitry such as, but not limited to, memory cells constructed using transistors, that are configured to store instructions. Similarly, the processor 210 can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices.

### Generating Raw Data

As described above, data ingest instruction data can be utilized to obtain raw data from a variety of data sources. In several embodiments, the obtained raw data can then be explored and visualized utilizing any of a variety of techniques, including those described above.

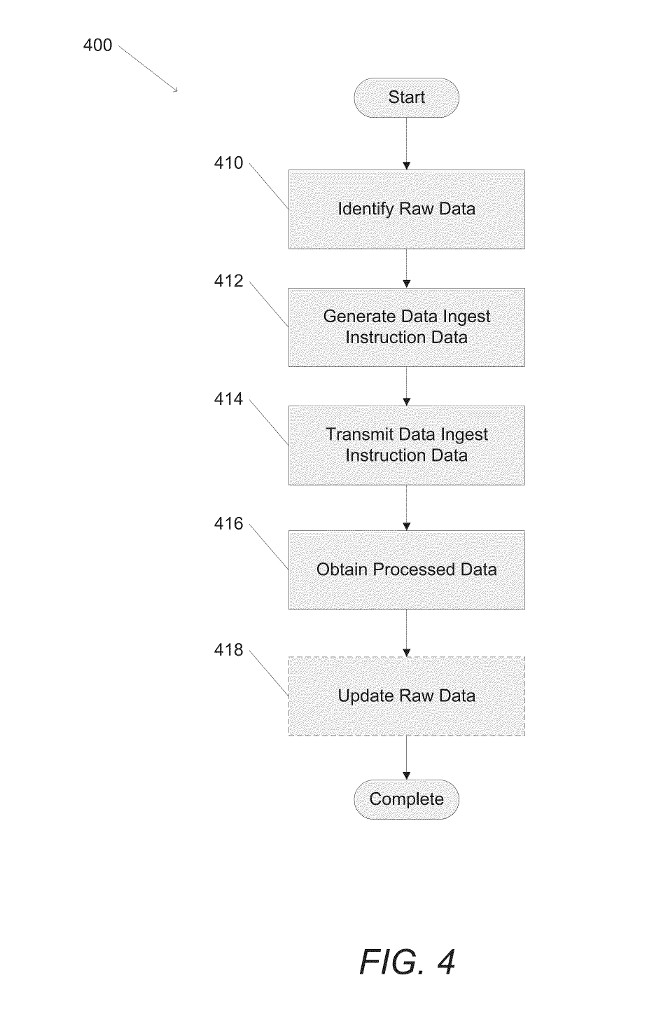

A process for generating raw data using data ingest instruction data in accordance with an embodiment of the invention is shown in FIG. 4. The process 400 includes identifying (410) raw data and generating (412) data ingest instruction data. In a number of embodiments, data ingest instruction data is transmitted (414). Processed data is obtained (416) and, in many embodiments, raw data is updated (418).

Although a specific process for utilizing data ingest instruction data to obtain raw data is described above with respect to FIG. 4, any of a variety of processes, including those that modify existing raw data utilizing data ingest instruction data, can be utilized in accordance with embodiments of the invention.

### Generating Source Data and Reporting Data

As described above, data ingest instruction data can be utilized to obtain a variety of raw data. Additionally, the data ingest instruction data can be utilized to generate source data and/or reporting data. That is, the data ingest instruction data can be utilized to perform ETL processes via one or more raw data storage systems as part of data generation processes in a variety of embodiments of the invention. The processed data generated based on the data ingest instruction data can then be incorporated into an interest-driven data pipeline to generate source data and/or reporting data as appropriate to the requirements of specific applications of embodiments of the invention.

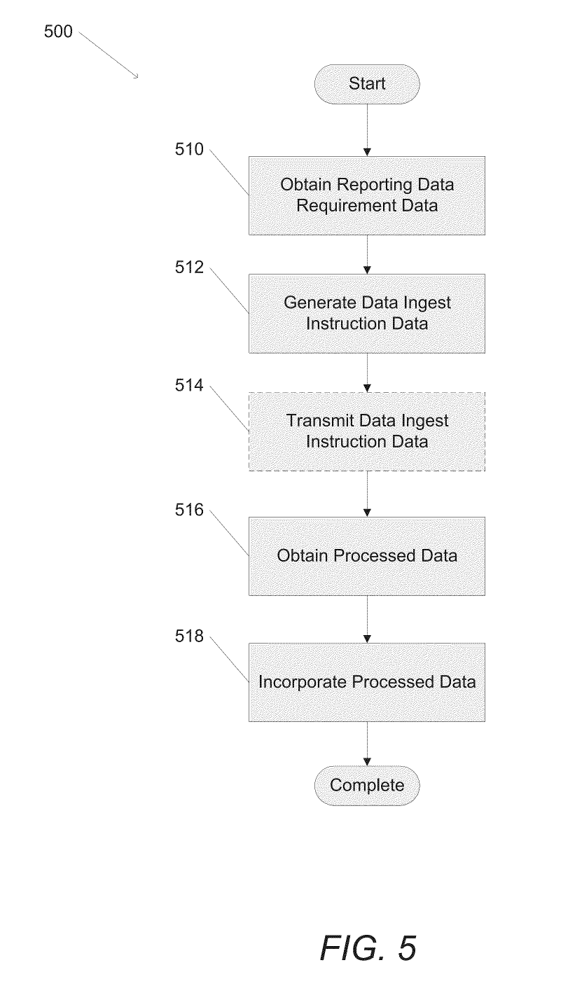

A process for incorporating processed data in accordance with an embodiment of the invention is shown in FIG. 5. The process 500 includes obtaining (510) reporting data requirement data and generating (512) data ingest instruction data. In several embodiments, data ingest instruction data is transmitted (514). Processed data is obtained (516) and incorporated (518).

Specific processes for generating reporting data and/or source data are described above with respect to FIG. 5; however, any of a variety of processes, including those that generate any type of data utilized within an interest-driven business intelligence system by generating and/or executing data ingest instruction data, can be utilized in accordance with embodiments of the invention.

### Generating Data Ingest Instruction Data

As described above, the generation of reporting data can include generating data ingest instruction data and obtaining source data generated based on the data ingest instruction data. In many embodiments, the generated data ingest instruction data is tailored to the specific capabilities of a particular data source. In this way, the data ingest instruction data can be optimized for a particular data source.

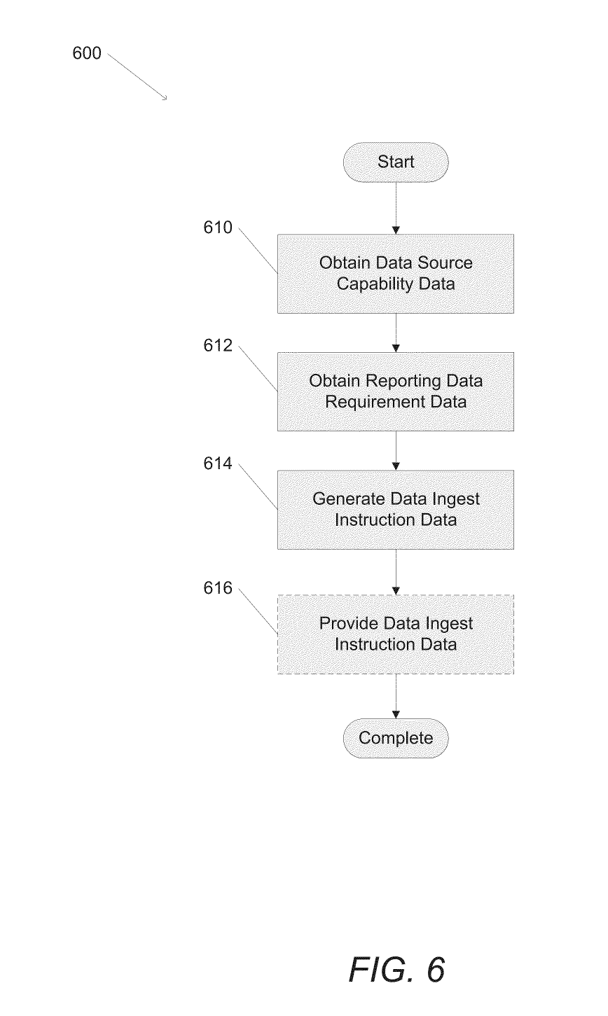

A process for generating data ingest instruction data in accordance with an embodiment of the invention is shown in FIG. 6. The process 600 includes obtaining (610) data source capability data, obtaining (612) reporting data requirement data, generating (614) data ingest instruction data, and, in a number of embodiments, providing (616) data ingest instruction data.

A specific process for generating data ingest instruction data is described above with respect to FIG. 6; however, any of a variety of processes, including those that utilize alternative techniques for generating data ingest instruction data and those that generate multiple pieces of data ingest instruction data for obtaining data from a set of data sources, can be utilized in accordance with embodiments of the invention.

### Receiving and Storing of a Registered Function

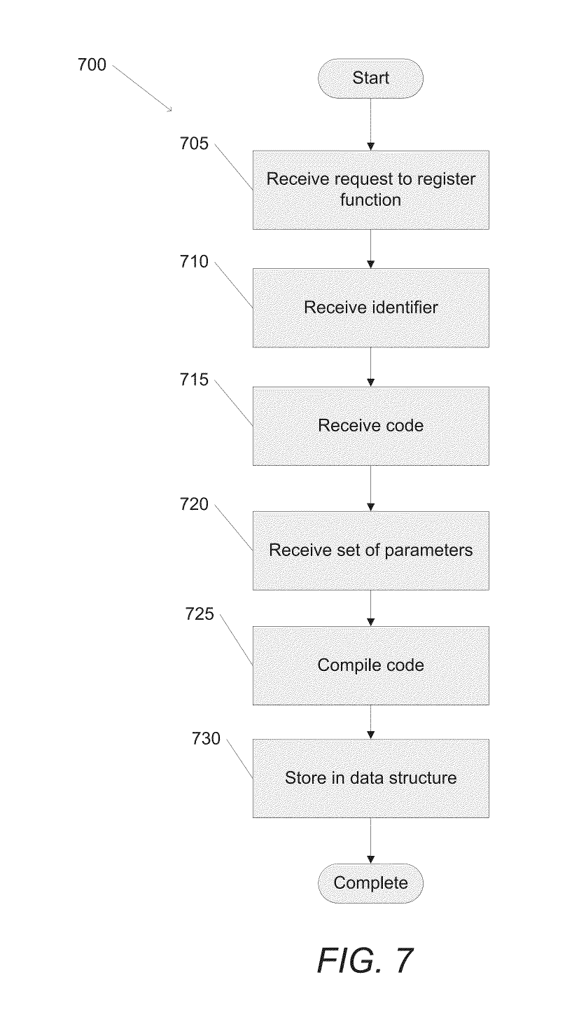

In accordance with embodiments of this invention, pre-defined functions that are expressed using the data ingest instruction data can be registered with the system for use by other. GUI 300 shown in the screen shot provided in FIG. 3A is a GUI in accordance with an embodiment of this invention that provides predefined functions that can be expressed using the data ingest instruction data in accordance with an embodiment of this invention. A process of registering a function with the system in accordance with an embodiment of the invention is shown in FIG. 7.

In process 700, the system receives an input request to register a function (705). The input of the function can be a textual input entered via a prompt on a display screen and/or a selection or “click” on an object in a display screen in accordance with some embodiments of the invention. Furthermore, the registration request can include one or more users and/or classes of user that are to be allowed access to the registered function in accordance with some embodiments of the invention. In accordance with a number of embodiments, the type of function may also be input. For example, in some embodiments, the function may be a table function that new rows or a new dataset to the data or a scalar that adds a new column or dimension to an existing dataset. In the shown embodiments, the table functions are shown by tab 302 and the scalar functions are shown by tab 304 in FIG. 3A. The process 700 receives an identifier to associate with the function that will be used to identify the function (710). In many, embodiments the identifier also include one or more description fields that describe the function in some way to allow a user to understand the use of the function. A screenshot of a GUI 310 that allows a user to register a function in accordance with an embodiment of an invention is shown in FIG. 3B. GUI 310 includes fields for inputting a function name 312 and a description of the function 314. In accordance with various other embodiments, other fields can be provided to allow the user to register the function. Examples of other fields include, but are not limited to, fields to input users and/or classes of users that have access to the function, fields allowing to register which data sources may be used with the function and various descriptor fields. Furthermore, one skilled in the art will recognize that other types of interfaces be provided to register a function in accordance with various other embodiments of the invention.

The process 700 receives the code for the function that is generated in a language supported by the system (715). In some embodiments, the code can be generated in one of multiple languages supported by the system. An example of a language that can be supported by the system in accordance with some embodiments of the Scala language is provided by École Polytechnique Fédérale de Lausanne of Lausanne, Switzerland. However, other languages can also be supported. In accordance with some embodiments, the code can be received in a file or other data structure storing the code that is read or imported by process 700. A file provided the coding for a function in accordance with an embodiment of this invention is shown in GUI 320 in the screenshot illustrated in FIG. 3C.

The process 700 can also receive a set of parameters of the function to expose to a user (720). The set of parameters includes one or more variables that can be changed to change the performance of the function. Examples of variables in accordance with some embodiments of the invention include, but are not limited to, the number of clusters to use and a string to be searched for in a particular field. In accordance with many embodiments, a default value for the parameters may also be included. An example of a set of parameters exposed to a user in accordance with an embodiment of this invention is shown in GUI 330 in the screenshot shown in FIG. 3D. In GUI 330, two parameters, target product 333 and clusters 334 of a product affinity function are exposed to the user.

The process 700 can compile the code for the function (725) and stores the compiled code in a data structure that also includes the identifier that is accessible by the system (730). The data structure can also store the exposed set of parameters and/or any descriptive fields associated with the function. The data structure can then be used at a later time to provide the predefined function to user for use in generating data ingest instruction data. In a variety of embodiments, the code is stored directly in the data structure and executed directly and/or complied at run time.

A specific process for registering a function for use in generating data ingest instruction data is described above with respect to FIG. 7. However, any of a variety of processes, including those that utilize alternative techniques for registering functions for use in generating data ingest instruction data can be utilized in accordance with embodiments of the invention.

### Performing a Registered Function on Data

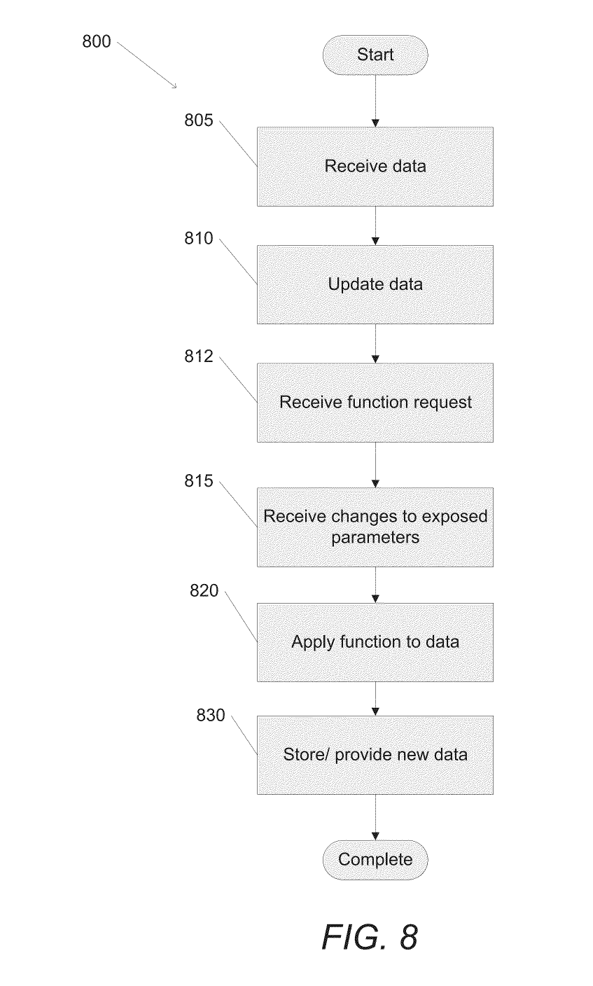

After data ingest instruction data that provides a function is registered, a user that is permitted to use the function can apply the data ingest instruction data for the function to data to generate new data. A process for applying the data ingest instruction data for a register function to data to generate new data in accordance with an embodiment of the invention is shown in FIG. 8.

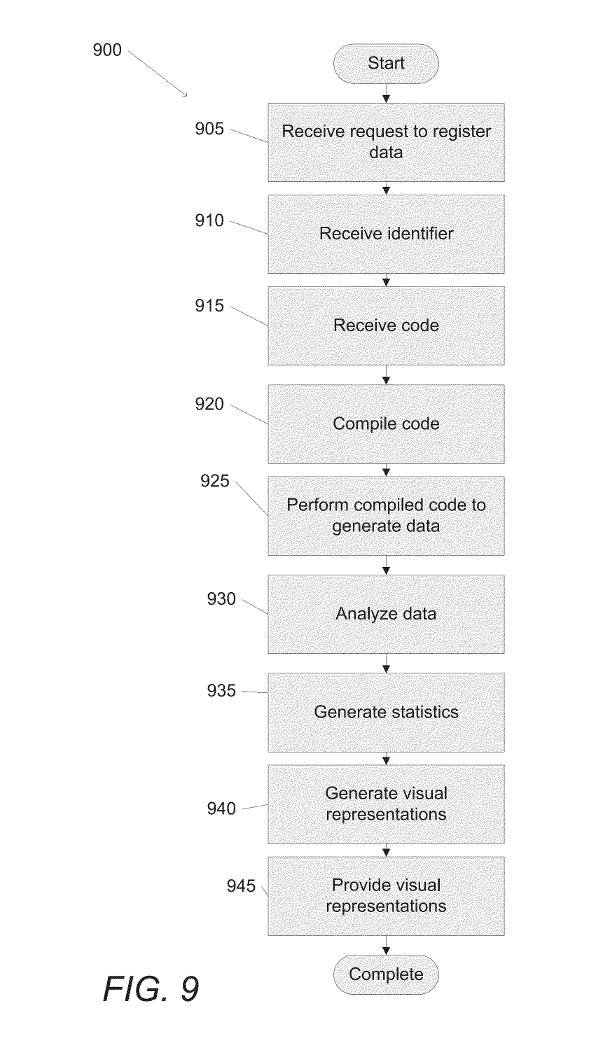

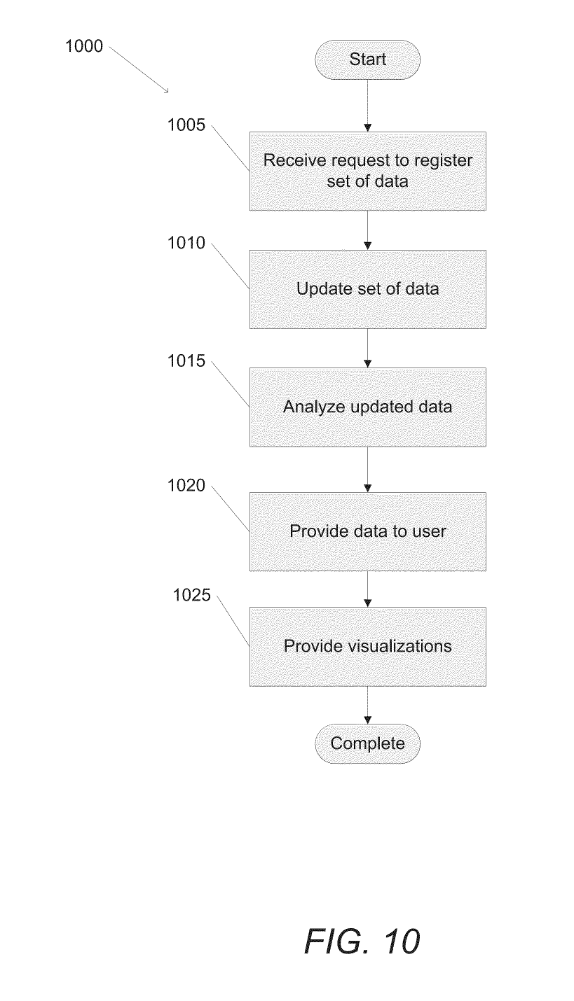

In process 800, a set of data or data ingest instruction data for generating the set of data is received (805). In some embodiments, the set of data can be an existing set of data such as data generated using a previous set of data ingest instruction data available to the system as described below with respect to FIGS. 9-10. In some other embodiments, data ingest instruction data to generate a set of data can be received.

The set of data can be generated using the received data ingest instruction data or updated using data ingest instruction data associated with the received set of data (810). A request to perform the function defined by the registered data ingest instruction data is received (812). In accordance with some embodiments, the request can be received in the form of an input of a string including the identifier of the function input using a command prompt in a shell provided by the system as shown in FIG. 3H. In some other embodiments, the request can be an interaction with an object in an interface identifying the registered function in a user interface such as interface 340 shown in the screenshot provided in FIG. 3E.

The process 800 can receive changes to one or more of the parameters in the exposed set of parameters for the function (815). The data ingest instructions data of the function is then applied to the set of data using the changes to the exposed set of parameters to generate new data (820). The new data is then provided by the process for use (825) and can be optionally stored by the system.

A specific process for using data ingest instruction data for a registered function to generate new data is described above with respect to FIG. 8. However, any of a variety of processes, including those that utilize alternative techniques for using a registered function can be utilized in accordance with embodiments of the invention.

Registering a Set of Data Generated from Data Ingest Instruction Data

In accordance with some embodiments of the invention, a set of data generated from data ingest instruction data can be registered with the system to allow others to use to generated set of data. The generated data can be source data, reporting data or any other type of data provided by the system. In accordance with some embodiments, the data ingest instruction data used to generate the data can be a resilient distributed data set that is a fundamental building block in the Apache Spark framework provided by the Apache Software Foundation of Forest Hill, Md. A process for registering a set of data generated by data ingest instruction data in accordance with embodiments of this invention is shown in FIG. 9.

In process 900, a request to register a set of data generated by ingest instruction data is received (905). In accordance with some embodiments, the request can be received by a selection of object in a user interface. In accordance with some other embodiments, the request can be in the form of a command input at a prompt in a shell or other interface provided. In accordance with a number of embodiments, the request can also include users and/or sets of users that are permitted to access the data ingest instruction data. An identifier for the set of data ingest data is received (910). In accordance with some embodiments, the identifier can be received with the request to register the data ingest instruction data. The code that provides the data ingest instruction data is received (915) and can be compiled (920). The (compiled) data ingest instruction data is then performed to generate the set data (925).

The process analyzes the generated data (930) and generates statistics for the generated data (935). In accordance with some embodiments, the statistics can include, but are not limited to, the number of occurrences of each different type of a particular data is present in a given field of the data, the average value of data in a particular field, any other statistical value that can be determined from a set of data, and/or missing data. In accordance with a number of embodiments, the statistics can be metadata for the generated data. The process can then generate visual representations for the statistics for use presentation to a user (940). An example of visual representations of statistics are shown in panels 342 and 352 of interfaces 340 and 350 shown in FIGS. 3E and 3F respectfully. The compiled code, the identifier, generated data, statistics for the data, and/or visual representations of statistics can be stored in a data structure in a memory accessible by the system for later use by a permitted user (945). In accordance with some embodiments, the statistics can be stored as metadata for the generated data and store appropriately.

A specific process for registering a set of data ingest instruction data is described above with respect to FIG. 9. However, any of a variety of processes, including those that utilize alternative techniques for registering a set of data ingest instruction data can be utilized in accordance with embodiments of the invention.

Using a Registered Set of Data Generated from Data Ingest Instruction Data

After a set of data generated from data ingest instruction data is registered, a user that is permitted to use the registered data can access the data. A process for providing access to a registered set of data in accordance with an embodiment of this invention is shown in FIG. 10.

In process 1000, a request is received for a registered set of data (1005). In accordance with some embodiments, the registered set of data is selected from a catalog of sets of data available to the user. In accordance with some of these embodiments, the request is made by interacting with an object represented the registered set of data in an interface. In accordance with some other embodiments, the request is provided as an input string in a command prompt that includes the identifier of the set of data.

The set of data can then be optionally updated using the stored data ingest instruction data used to generate the set of data (1010). The updated set of data can be analyzed and the statistics and visual presentation for the statistics can also be updated (1015). The set of data or the updated set of data can be provided to the user (1020). An example of visual representations of the new data in accordance with an embodiment of the invention is shown in panels 344 and 354 of interfaces 340 and 350 shown in FIGS. 3E and 3F respectfully. The visualizations of the statistics can also be provided to the user (1025). An example of visual representations of updated statistics are shown in panels 342 and 352 of interfaces 340 and 350 shown in FIGS. 3E and 3F respectfully. In accordance with some embodiments, the visualizations of the statistics can only be provided in response to a user request to view the visualizations. The user can then use the visualizations of the statistics to change the data ingest instruction data to change the data set to include a more desirable data.

A specific process for using a registered set of data generated from data ingest instruction data is described above with respect to FIG. 10. However, any of a variety of processes, including those that utilize alternative techniques for using a registered set of data generated from registered ingest instruction data can be utilized in accordance with embodiments of the invention.

Although the present invention has been described in certain specific aspects, many additional modifications and variations would be apparent to those skilled in the art. In particular, any of the various processes described above can be performed in alternative sequences and/or in parallel (on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An interest-driven business intelligence server system comprising:
a processor;
memory connected to the processor that stores an interest-driven business intelligence application, source data, aggregate data, and data ingest instruction data;
data storage that stores raw data; and
wherein the interest-driven business intelligence application directs the processor to:
maintain a set of registered data ingest instruction data that includes at least one registered data ingest instruction data wherein each of the at least one registered data ingest instruction data includes an identifier and data ingest instruction data associated with the identifier;
receive a request to generate data using registered data instruction data wherein request includes the identifier of the registered data instruction data;
generate data using the data ingest instruction data associated with the requested identifier and at least one of raw data, source data, and aggregate data, and
provide the generated data for use.

2. The interest-driven business intelligence server system of claim 1, wherein the interest-driven business intelligence application further directs the processor to:
analyze the generated data;
generate statistic data for the generated statistics for the generated data; and
provide the statistic data for use.

3. The interest-driven business intelligence server system of claim 2, wherein the statistic data is provided as metadata associated with the generated data.

4. The interest-driven business intelligence server system of claim 1, wherein the generating of the data using data ingest instruction data comprises updating a set of data generated using the data ingest instruction data associated with the identifier.

5. The interest-driven business intelligence server system of claim 1, wherein the interest-driven business intelligence application further directs the processor to store the generated data in memory.

6. The interest-driven business intelligence server system of claim 1, wherein the interest-driven business intelligence application further directs the processor to:
receive a request to register data ingest instruction data;
receive an identifier associated with the data ingest instruction data to register;
receive code written in a supported language to generate the data ingest instruction data;
compile the code to generate the data ingest instruction data; and
store the data ingest instruction data and the associated identifier as registered data ingest instruction data in memory.

7. The interest-driven business intelligence server system of claim 6, wherein the interest-driven business intelligence application further directs the processor to:
generate data using the data ingest instruction data associated with the identifier in response to compiling the code to generate the data ingest instruction data; and
store the generated data in memory as part of a data catalog maintained in memory, wherein the data is associated with the identifier in the data catalog.

8. The interest-driven business intelligence server system of claim 1, wherein the registered data ingest instruction data is a function to perform on a set of data.

9. The interest-driven business intelligence server system of claim 8, wherein the interest-driven business intelligence application further directs the processor to:
receive an identification of a set of data to which the registered data ingest instruction data is to be applied;
obtain the set of data;
apply the ingest instruction data associated with the identifier to the set of data to generate data.

10. The interest-driven business intelligence server system of claim 9, wherein:
the interest-driven business intelligence application further directs the processor to receive a change to at least one variable in a set of parameters for the data ingest instruction data exposed for use; and
the ingest instruction data is applied with to the data set using the change to the at least one variable in the set of parameter exposed for use.

11. The interest-driven business intelligence server system of claim 8, wherein the interest-driven business intelligence application further directs the processor to:
receive a request to register data ingest instruction data that provides a function;
receive an identifier associated with the data ingest instruction data to register;
receive code written in a supported language to generate the data ingest instruction data;
receive a set of parameters including at least one variable for the data ingest instruction data that provides the function to expose to a user to allow the user to change;
compile the code to generate the data ingest instruction data; and
store the data ingest instruction data, the exposed set of parameters and the associated identifier as registered data ingest instruction data in memory.

12. A method performed by an interest-driven business intelligence server system to provide data for an interest-driven data pipeline comprising:
maintaining a set of registered data ingest instruction data using the interest-driven business intelligence server system that includes at least one registered data ingest instruction data wherein each of the at least one registered data ingest instruction data includes an identifier and data ingest instruction data associated with the identifier;
receiving a request using the interest-driven business intelligence server system to generate data using registered data instruction data wherein request includes the identifier of the registered data instruction data; and
generating data using the interest-driven business intelligence server system from the data ingest instruction data associated with the requested identifier and at least one of raw data, source data, and aggregate data, and
providing the generated data to the interest-driven data pipeline using the interest-driven business intelligence server system.

13. The method of claim 12, further comprising:
analyzing the generated data using the interest-driven business intelligence server system;
generating statistic data for the generated statistics for the generated data using the interest-driven business intelligence server system; and
providing the statistic data to the interest-driven data pipeline using the interest-driven business intelligence server system.

14. The method of claim 13, wherein the statistic data is provided as metadata associated with the generated data.

15. The method of claim 12, wherein the generating of the data from the data ingest instruction data comprises updating a set of data generated using the interest-driven business intelligence server system based upon the data ingest instruction data associated with the identifier.

16. The method of claim 12, further comprising storing the generated data in memory.

17. The method of claim 12, further comprising:
receiving a request to register data ingest instruction data using the interest-driven business intelligence server system;
receiving an identifier associated with the data ingest instruction data to register using the interest-driven business intelligence server system;
receiving code written in a supported language to generate the data ingest instruction data using the interest-driven business intelligence server system;
compiling the code to generate the data ingest instruction data using the interest-driven business intelligence server system; and
storing the data ingest instruction data and the associated identifier as registered data ingest instruction data in memory using the interest-driven business intelligence server system.

18. The method of claim 17, further comprising:
generating data using the data ingest instruction data associated with the identifier in response to compiling the code to generate the data ingest instruction data using the interest-driven business intelligence server system; and
storing the generated data in memory as part of a data catalog maintained in memory, wherein the data is associated with the identifier in the data catalog using the interest-driven business intelligence server system.

19. The method of claim 12, wherein the registered data ingest instruction data is a function to perform on a set of data.

20. The method of claim 19, further comprising:
receiving an identification of a set of data to which the registered data ingest instruction data is to be applied in the interest-driven business intelligence server system;
obtaining the set of data using the interest-driven business intelligence server system;
applying the ingest instruction data associated with the identifier to the set of data to generate data using the interest-driven business intelligence server system.

21. The method of claim 20, further comprising:
receiving a change to at least one variable in a set of parameters for the data ingest instruction data exposed for use using the interest-driven business intelligence server system; and
wherein the ingest instruction data is applied with to the data set using the change to the at least one variable in the set of parameter exposed for use in the interest-driven business intelligence server system.

22. The method of claim 19, further comprising:
receiving a request to register data ingest instruction data that provides a function using the interest-driven business intelligence server system;
receiving an identifier associated with the data ingest instruction data to register in the interest-driven business intelligence server system;
receiving code written in a supported language to generate the data ingest instruction data using the interest-driven business intelligence server system;
receiving a set of parameters including at least one variable for the data ingest instruction data that provides the function to expose to a user to allow the user to change using the interest-driven business intelligence server system;
compiling the code to generate the data ingest instruction data using the interest-driven business intelligence server system; and
storing the data ingest instruction data, the exposed set of parameters and the associated identifier as registered data ingest instruction data in memory using the interest-driven business intelligence server system.
